(19) United States
(12) Patent Application Publication
(10) Pub. No.: US 2018/0126775 A1
(43) Pub. Date: May 10, 2018

(54) Wax Decal

(71) Applicants: John Paul Canton, Coronado, CA (US); Christopher Edward Canton, Spring Valley, CA (US)

(72) Inventors: John Paul Canton, Coronado, CA (US); Christopher Edward Canton, Spring Valley, CA (US)

(21) Appl. No.: 15/344,474

(22) Filed: Nov. 4, 2016

(51) Int. Cl. B44C 1/17; B29C 65/00; B65C 9/30; B65C 1/02

(52) U.S. Cl. CPC B44C 1/1737; B29C 66/45; B29K 2691/00; B65C 9/30; B65C 1/02; B29C 66/828

(57) ABSTRACT

A wax decal production and application system is disclosed involving a wax sheet, an indentation roller, a method of cutting the wax sheet, and a roller to apply the sheet to a surface. A thin wax sheet is extruded through drums that pattern it with indentations. A design is cut into the sheet and the extraneous material is removed. The wax decal is placed upon a surface. With the use of a roller, the indentations are crushed, collapsing onto and sticking to the surface.

### BACKGROUND

The present invention relates to the application of wax to surfaces where a design is cut out of a thin sheet of wax, matted with a pattern of indentations, and applied to surfboards and other surfaces for traction and for aesthetic display.

Traction pads for surfboards have been in existence for years. Most are made of foam and applied to the surfboard with a glue adhesive. Being semi-permanent in nature, these commonly used foam traction pads are costly and difficult to remove.

Other wax application systems for surfboards exist, yet are inconvenient and limited. One involves a sticker applied to a surfboard before a bar of wax is rubbed over the sticker so that a design emerges. Being semi-permanent in nature, the stickers are under the wax and difficult to remove. The system is limited to single-color designs. Another system involves images printed on transparent plastic sheets and sandwiched between two sheets of wax.

Existing traction pads and wax application systems suffer from one or more shortcomings with respect to surf sports. The first is excessive adhesion to the board. Many existing traction pads are made of foam, designed with an adhesive bottom surface which is intended to form a strong affixation to the surfboard yet it leaves the pad difficult to remove. The second shortcoming is that the cost of production for existing foam traction pads are often high. Thirdly, existing wax application systems are limited to a single color or have plastic inserts.

### SUMMARY

This document discloses a wax decal production and application system. A mixture of beeswax, paraffin wax, microcrystalline wax, and other chemicals, are heated to a liquid state. The preferred method is to achieve sheets of wax indented with a pattern. The heated wax mixture is poured over a cold drum and passed through an extruder, producing thin sheets. The sheets pass through patterned drums and become matted with a pattern of projections and recesses which form indentations in the sheets. Designs are cut out of the indented sheets. The cut-out wax decals are placed between two plastic sheets. Application of the wax decal occurs with a roller, where a plastic sheet is removed and the wax design is placed onto a chosen surface, such as a surfboard. The decal is adapted onto the surface with a roller as the pressure of the roller works to collapse the indentations and flatten the design, causing it to affix to the surface. The top plastic sheet is removed and the wax decal remains.

In one aspect, a wax sheet is presented with numerous indentations across its surface. The indentations function to affix the wax sheet to a surface. In some implementations, a wax sheet uses multiple colors, all-wax decals that adhere to a surfboard yet are easy to remove.

In another aspect, the wax sheet is part of a wax design production and application system that further includes a process of boiling waxes, extruding, printing, indenting, cutting, separating extraneous material, placing the wax designs between two plastic sheets, and then using a roller, crushing the indentations to cause affixation to the surface, resulting in the presentation of a wax decal.

The details of one or more embodiments are set forth in the accompanying drawings and the description below. Other features and advantages will be apparent from the description and drawings, and from the claims.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1A is an illustration of a wax decal application system 100, including a view of a plastic sheet 16 placed over a thin wax decal 14. The decal 14, being patterned with indentations 35, is applied with the preferred pressure of a cylindrical roller 20, where the indentations 35 collapse and flatten causing affixation to a surface 15. FIG. 1B illustrates a plastic sheet 16 being removed and shows that the wax decal 14 remains adhered to the surface 15.

FIG. 2 is a cross-sectional side view of a wax decal 14 patterned with the hollow indentations 35 in accordance with preferred implementations of the wax decal application system before its application to a surface.

FIG. 3A is an illustration of beeswax, FIG. 3B is of paraffin wax, and FIG. 3C is of microcrystalline wax, the ingredients of the preferred chemical composition of the wax sheet.

FIG. 4 illustrates a wax decal production system 200, where the ingredients are mixed and heated to form a uniform liquid wax mixture 10.

FIG. 5 further illustrates a wax decal production system 200, where an extrusion process using cold drums 11 solidifies the liquid wax mixture 10 and extrudes the substance into smooth wax sheets 12.

FIG. 6 further illustrates a wax decal production system 200, comprising the indentation tool 30, whereby the surface of the wax sheet 12 is imprinted with a pattern of indentations 35. The indentation tool is made of up two drums 31 that are carefully timed 34 and positioned to extrude indentations 35 in the wax sheet 12. Each drum 31 has two main parts: a sheath 32, and an axle 33. In the preferred embodiment, the sheath 32 is made of hard plastic, and the axle 33 is made of metal.

FIGS. 7A-7E further illustrate a wax decal production system 200 with five methods of cutting a design into the indented wax sheet 13. FIGS. 7A-1 and 7A-2 illustrate a laser 42 cutting the wax sheet 13 preferably using a cool perforated vacuum platform 40 with an airflow 41. FIG. 7B illustrates the use of a Computer Numerical Control (CNC) machine to cut the wax sheet 13, preferably using a heated blade 43, cool platform 40, and airflow 41. FIG. 7C illustrates a die 44 cutting the wax sheet 13, which can also utilize a heated tool, cool platform 40, with an airflow 41 to facilitate the cutting process. FIG. 7D illustrates pressurized heated air, water, or gas 45, directed to cut the wax sheet 13 which can also be positioned on a cool platform 40 with an airflow 41. An alternative implementation is shown in FIG. 7E, a three-dimensional (3D) printer that prints wax through a heated wax filled syringe 46.

FIG. 8 further illustrates a wax decal production system 200 with a separator tool that is comprised of a vacuum box 50 which is used to separate the cut-out wax decal 14 from extraneous material 53 by using a template 51.

FIGS. 9A-9D further illustrate a wax decal application system 100 with the wax decal 14 between a plastic sheet 16 and a surface 15. FIG. 9A is a pre-application cross sectional view of the wax decal 14 between the surface 15 and a plastic sheet 16. FIG. 9B is a cross-sectional side view illustrating the use of the cylindrical application tool 20 rolling over the plastic sheet 16, causing the indentations 35 in the wax decal 14 to collapse onto the surface 15. FIG. 9C is a cross-sectional side view illustrating the plastic sheet 16 being removed from the wax decal 14 which remains adhered to the surface 15. FIG. 9D is a top view illustrating the plastic sheet 16 being removed from the wax decal 14 which remains adhered to the surface 15. FIGS. 9A-9C show that upon the application of the wax decal 14 to the surface 15, the indentations 35 have collapsed, flattened, and caused affixation to the surface 15, and after the top plastic sheet 16 is removed, a traction pad remains on the surface 15 in the form of a wax decal 14.

Like reference symbols in the various drawings indicate like elements.

### DETAILED DESCRIPTION

This document describes a wax design production and application system that is particularly suitable for the sport of surfing, providing an aesthetic solution that enables greater freedom in the application and removal of a traction pad, and allows for more versatile application of designs than conventional traction pads.

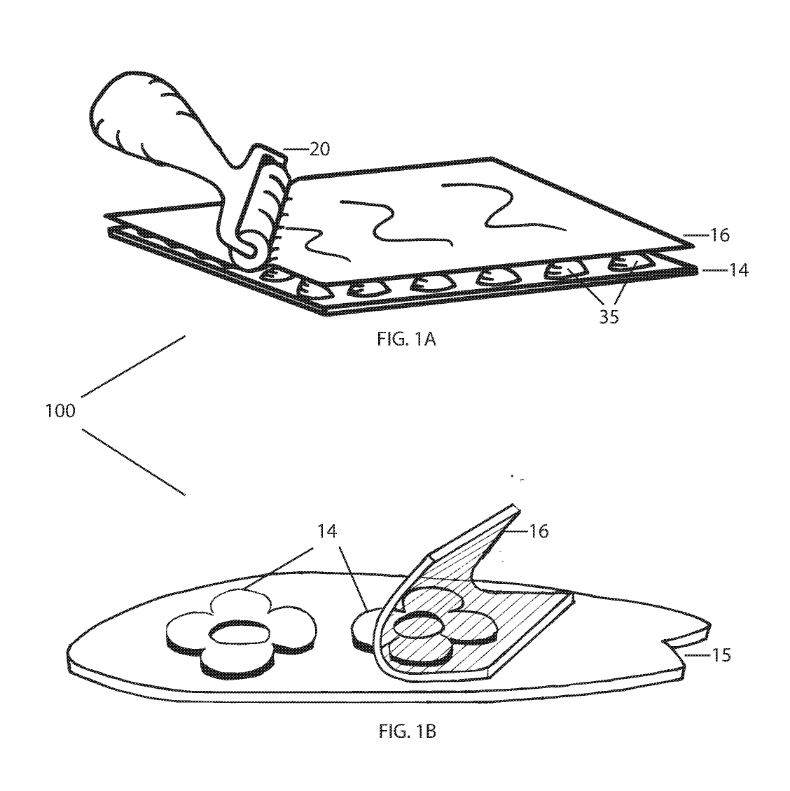

Referring to FIGS. 1A-1B, a wax decal application system 100 is disclosed which includes a wax decal 14, a plastic sheet 16, and a cylindrical application tool 20. The wax decal 14 is shaped and configured to be flattened against a surfboard or other surface 15 to enable traction for the rider in the form of an appealing design. Rolling the cylindrical tool 20 on the plastic sheet 16 causes the hollow indentations 35 to collapse and flatten, enabling the wax decal 14 to stick to the surface 15, resulting in a useful wax traction pad in the form of an affixed aesthetic design, the wax decal 14.

Referring to FIG. 2, the wax sheet 13 has projections and indentations 35 which form hollow shaped impressions into its surface. In exemplary implementations, the wax sheet 13 is generally a plane with projections and recesses, described herein as indentations 35, on its surface. The indentations 35 can be different sizes and shapes so far as symmetry is preserved on the surface of the wax sheet 13.

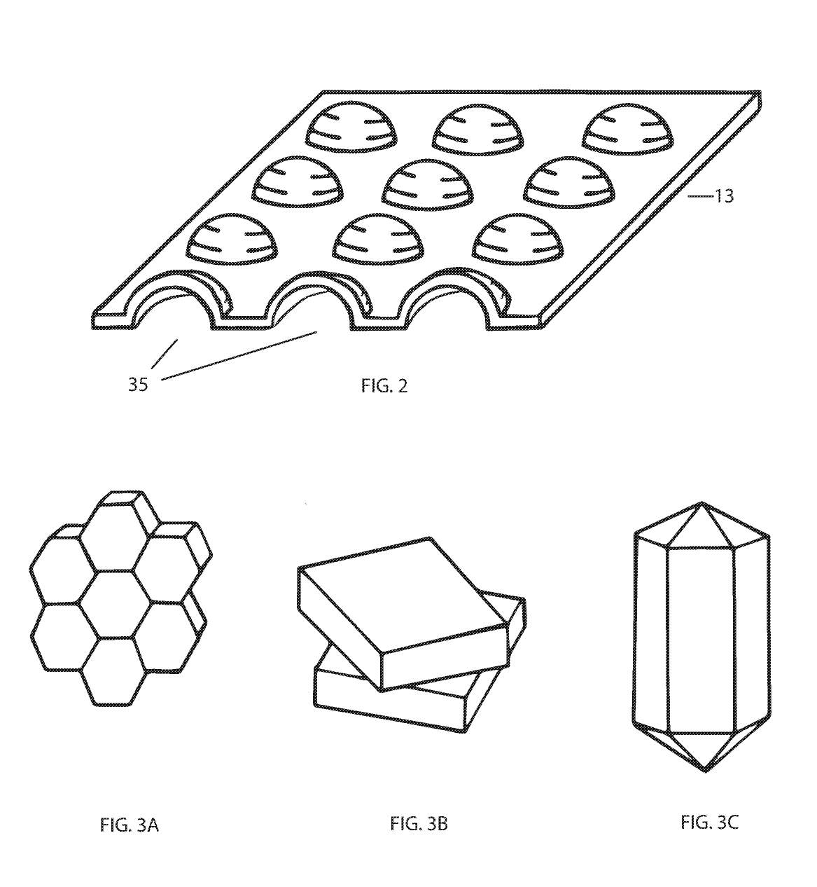

Referring to FIGS. 3A-3C, the composition of the liquid wax mixture 10 is a combination of beeswax (FIG. 3A), paraffin wax (FIG. 3B), and microcrystalline wax (FIG. 3C), although alternative combinations may be used including the use of petroleum, soy, pine resin, tree pulp, vegetable oils, or synthetic wax.

Referring to FIG. 4, a wax decal production system 200 is illustrated by heating a mixture of the materials described in FIGS. 3A-3C to a liquid state 10.

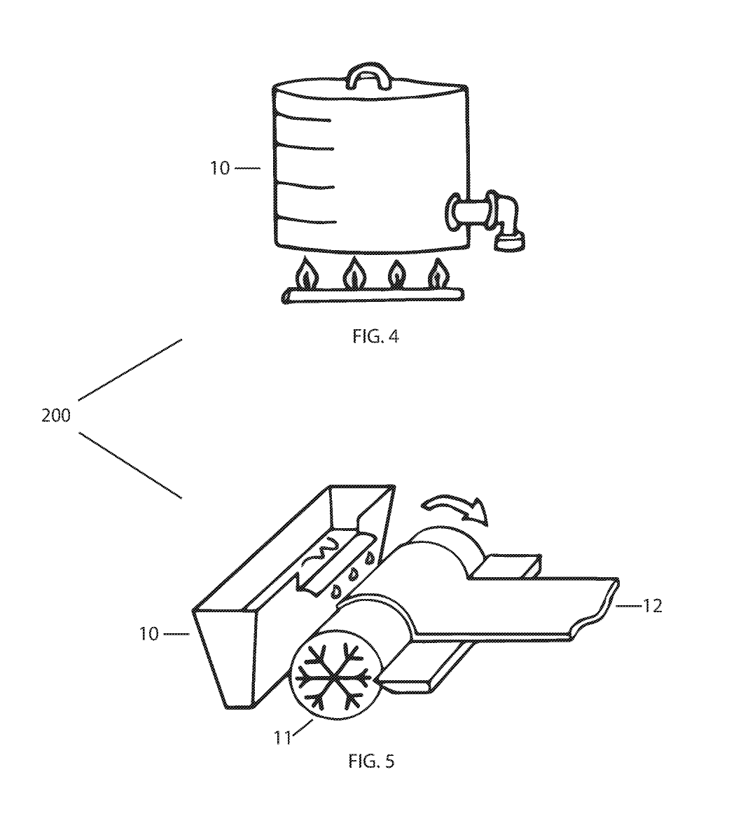

Referring to FIG. 5, a wax decal production system 200 is further illustrated as the heated liquid wax 10 is extruded through cooled cylindrical drums 11 where it instantly hardens into a smooth planar wax sheet 12. The wax sheet 12 is preferably of uniform width, but it can have sections that have a larger width or that vary. The wax sheet 12 has a thickness of 1/16 to ⅛ inch, although the thickness can range from 1/32 inch to ⅜ inch.

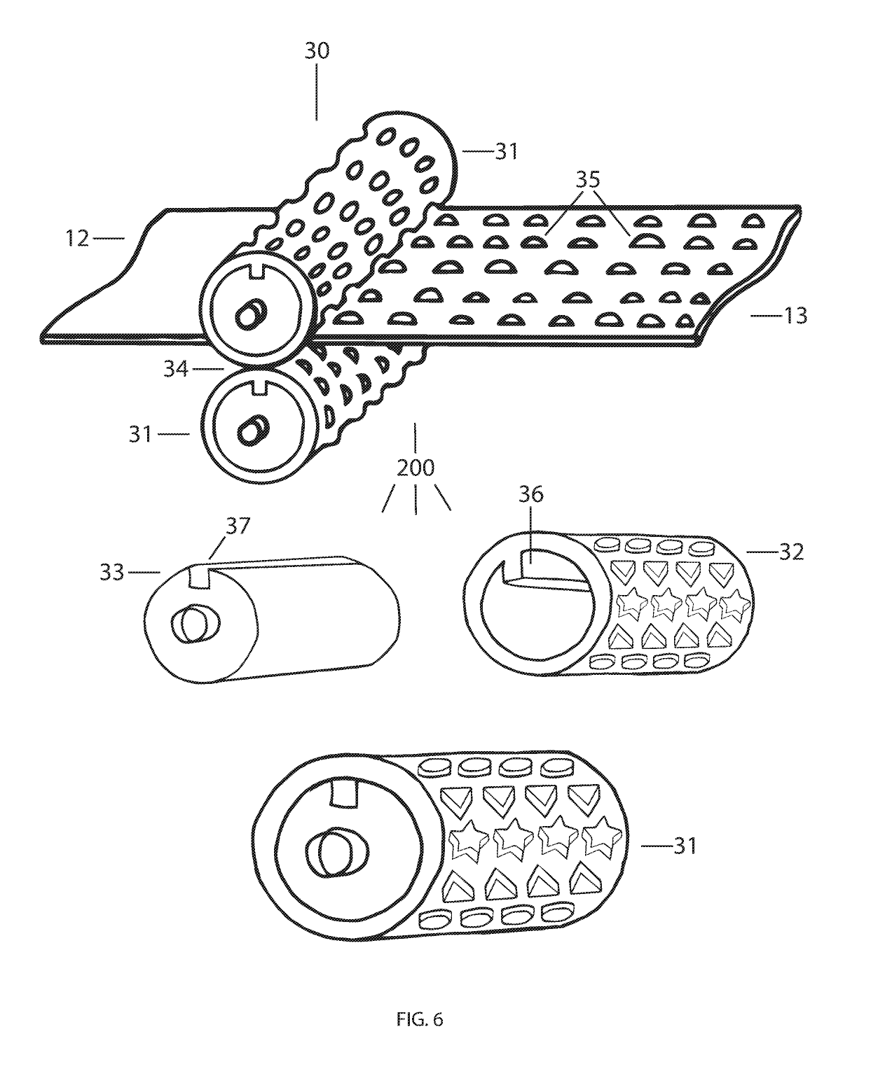

Referring to FIG. 6, a wax decal production system 200 is further illustrated with the indentation tool 30 which has two drums 31 positioned and timed 34 to roll upon each other precisely so that the positive protrusions fit perfectly into the negative indentations of the opposite roller. The protrusions on one drum 31 and indentations on the other drum 31 are preferably of the same size and shape so that the projections and recesses can interlock. As the drums 31 roll upon each other, each protrusion fits perfectly into an accompanying indentation on the other roller. The drums 31 can be adjusted to allow enough space between them so that a desired thickness of a wax sheet 12 can pass through. As the wax sheet 12 passes through the rollers, it is indented with the pattern of indentations 35. This pattern of indentations can be easily interchanged by changing out the sheath 32. The sheath 32 is designed with a key 36 that slides snuggly into the corresponding slot 37 along the length of the axle 33. In an alternate embodiment, the method of indentation can be such that the patterns do not protrude deep in the wax sheet so that a different pattern of indentations 35 can be achieved on both sides of the wax sheet 12. The indented wax sheet 13 is preferably of uniform width, but it can have sections that have a larger width or that vary. The wax sheet 13 has a thickness of 1/16 to ⅛ inch, although the thickness can range from 1/32 inch to ⅜ inch.

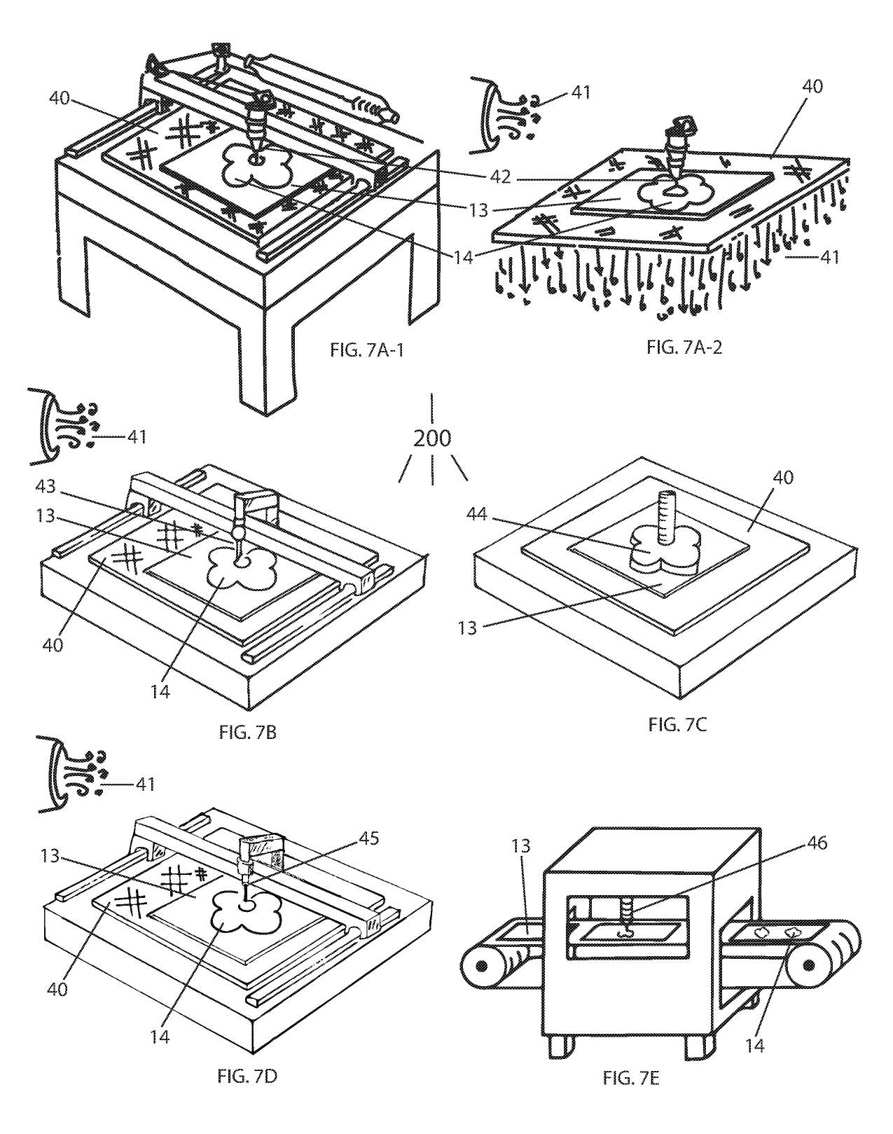

Referring to FIGS. 7A-7E, a wax decal production system 200 is further illustrated as a cutter tool 42, 43, 44, 45 makes an incision into the wax sheet 13 to cut the vector outlines of a wax decal 14. The cut is wide enough to provide the wax decal 14 complete separation from the extraneous material of the wax sheet 13. In the preferred implementation, a cutter tool 42, 43, 44, 45 operates in a cooled atmosphere 41 between forty and sixty degrees Fahrenheit. Also, a vacuum suction 40 is preferably present below the wax sheet 13 and a cold stream of air directed at the cutter tool 42, 43, 44, 45 and the wax sheet 13, which cools the incision, instantly cauterizing the material after it is cut. In this way, a cutter tool 42, 43, 44, 45 cuts a line into the wax sheet 13. The cooling process functions to instantly cauterize the edges of the cut by decreasing the temperature of the wax cutting area, stopping it from melting and providing the clean cut of a design in the wax sheet 13. FIGS. 7A-1 and 7A-2 show the laser 42 method of cutting the wax sheet 13. FIG. 7B illustrates the use of a Computer Numerical Control (CNC) machine to cut the wax sheet 13, preferably using a heated blade 43. FIG. 7C illustrates a die 44 cut, which can also utilize a heated tool, cool platform 40, with an airflow 41 to facilitate cutting the wax sheet 13. FIG. 7D illustrates a CNC using pressurized air, water, or gas 45, to cut lines in the wax sheet 13. An alternative implementation is shown in FIG. 7E, where a three-dimensional printer prints wax through a heated, wax-filled, syringe 46.

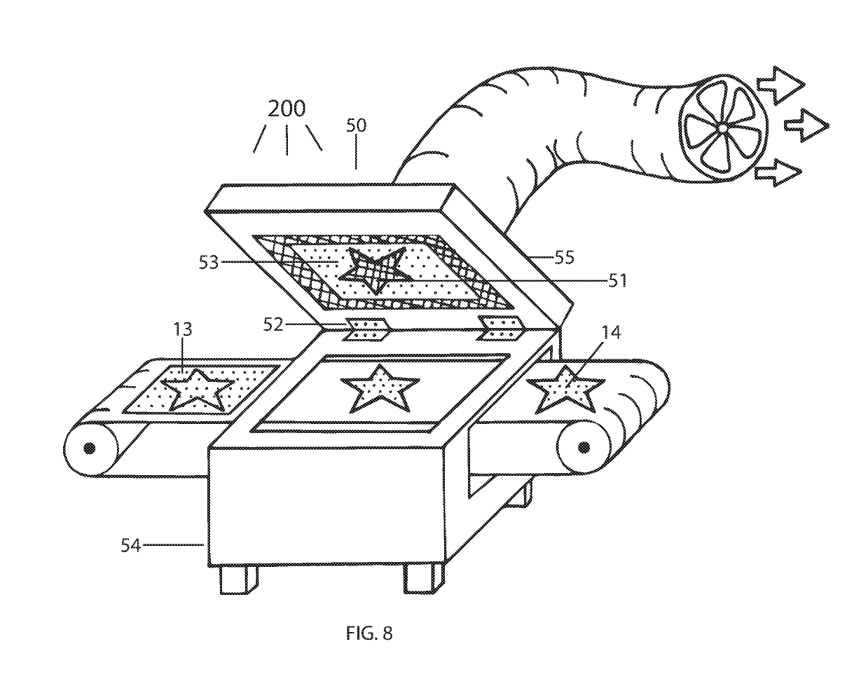

Referring to FIG. 8, a wax decal production system 200 is further illustrated as a separator tool 50 functions as a suction device with two vacuum boxes 54, 55 on opposite sides. The top vacuum 55 box having thereon a stencil of the design's negative 51 pulls air through the negative portions of the design on the wax sheet 13. The bottom vacuum box 54 has the cut wax sheet 13 centered thereon. FIG. 8 illustrates that the vacuum box folds on its hinges 52 and the template negative 51 overlaps exactly over the cut wax sheet 13. FIG. 8 illustrates how the top vacuum box 55 is lifted on its hinges 52 from the bottom part of vacuum box 54, and while the vacuums pull air in opposite directions, the top vacuum box pulls air through the template negative 51, lifting the extraneous wax 53 from the cut wax sheet 13, leaving the wax decal 14 on the bottom vacuum box 54.

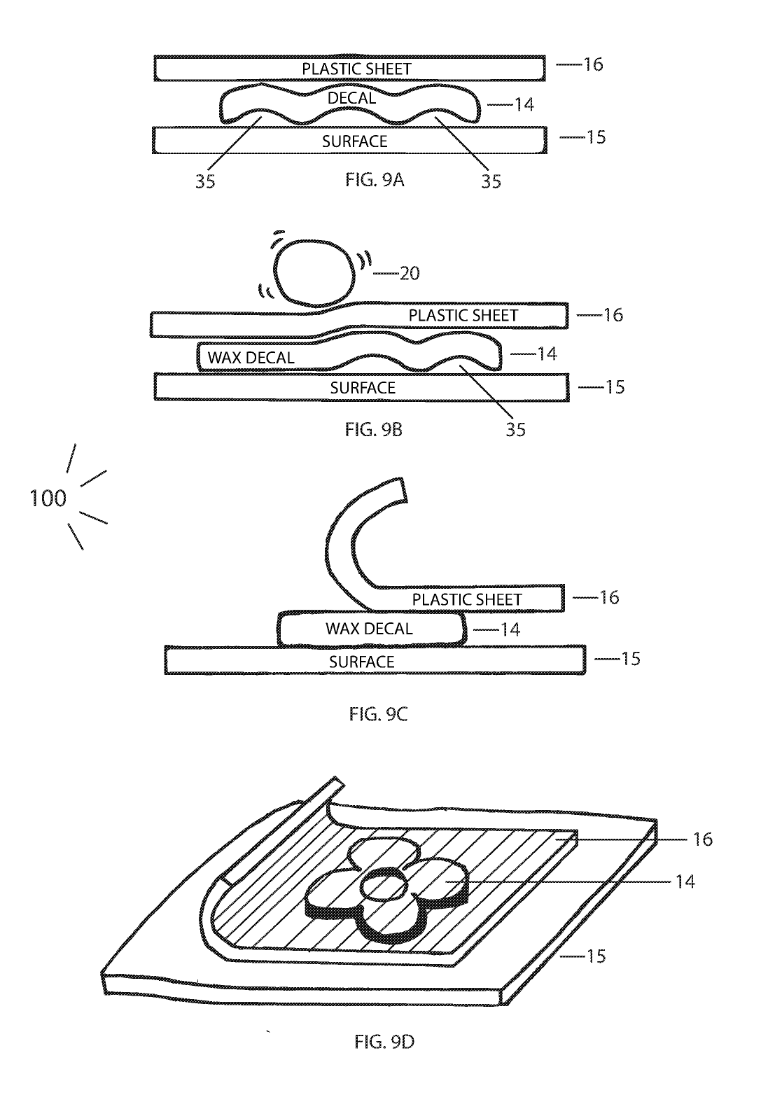

Referring to FIGS. 9A-9D, a wax decal application system 100 is further disclosed by which a wax decal 14 is applied to a surface 15. The wax decal 14, under a plastic sheet 16, is placed upon a surface such as a surfboard surface 15. As shown in the drawings, the cylindrical application tool 20 rolls on the sheets, compressing the indentations causing affixation of the wax decal 14 to the surface 15. FIGS. 9A-9C show, from a cross-sectional side perspective, that after the cylindrical roller 20 depresses the indentations 35 onto the surface 15, the plastic sheet 16 is removed from the wax decal 14. As shown in FIG. 9C, the wax decal 14 remains adhered to the surface 15.

Although a few embodiments have been described in detail above, other modifications are possible. Other embodiments may be within the scope of the following claims.

1. A wax decal apparatus for being adhered to a surface, the wax decal apparatus comprising:
a sheet of wax patterned with indentations, the sheet of wax being shaped present a design; and
a plastic sheet on the sheet of wax opposite the surface to which the sheet of wax is to be applied, the plastic sheet being removable from the sheet of wax upon application of the sheet of wax to the surface.

2. The wax decal apparatus in accordance with claim 1, wherein the sheet of wax further includes two or more shapes of different colors to present the design.

3. The wax decal apparatus in accordance with claim 1, further comprising a roller to collapse at least some of the indentations upon application of the sheet of wax to the surface.

4. The wax decal apparatus in accordance with claim 1, wherein the sheet of wax is formed of a combination of bees wax, paraffin wax, and microcrystalline wax.

5. The wax decal apparatus in accordance with claim 1, wherein the sheet of wax has a thickness between about 0.03125 and 0.375 inches.

6. A method of making a wax decal for being adhered to a surface, the method comprising:
forming wax into a sheet of wax;
shaping the sheet of wax into a design;
providing a pattern of indentations to at least a first side of the sheet of wax; and
applying a plastic sheet on the sheet of wax on a second side of the sheet of wax opposite the first side of the sheet of wax.

7. The method in accordance with claim 6, wherein the sheet of wax further includes two or more shapes of different colors to present the design.

8. The method in accordance with claim 6, wherein the indentations are sized and adapted to collapse against the surface upon application of the sheet of wax to the surface.

9. The method in accordance with claim 6, wherein the sheet of wax is formed of a combination of bees wax, paraffin wax, and microcrystalline wax.

10. The method in accordance with claim 6, wherein the sheet of wax has a thickness between about 0.03125 and 0.375 inches.
